(19) United States
(12) Patent Application Publication
(10) Pub. No.: US 2008/0094359 A1
(43) Pub. Date: Apr. 24, 2008

(54) Computer Mouse

(76) Inventor: Stefan Krichbaum, Vocklamarkt (AT)

Correspondence Address: COLLARD & ROE, P.C., 1077 NORTHERN BOULEVARD, ROSLYN, NY, 11576, US

(21) Appl. No.: 11/660,617

(22) PCT Filed: Aug. 31, 2005
(86) PCT No.: PCT/AT05/00350

§ 371 Date: Feb. 20, 2007

(30) Foreign Application Priority Data
Sep. 1, 2004 (AT) GM 645/2004

(51) Int. Cl. G06F 3/033

(52) U.S. Cl. 345/163

(57) ABSTRACT

A computer mouse is described, comprising a housing (1) which comprises a support surface (2) and a jacket surface (4) for finger support, which jacket surface protrudes upwardly in a tapering manner from the support surface (2). In order to provide advantageous handling conditions it is proposed that the jacket surface (4) is arranged in a conical way with generatrices extending substantially in a straight line and has a height of the width of three fingers for the purpose of supporting a thumb (5) on one circumferential side and an index finger and a middle finger (6, 7) on the opposite circumferential side.

### FIELD OF THE INVENTION

The invention relates to a computer mouse with a housing which comprises a support surface and a jacket surface for finger support, which jacket surface protrudes upwardly in a tapering manner from the support surface.

### DESCRIPTION OF THE PRIOR ART

Conventional computer mice have a flat housing which on the upper side opposite of the support surface carriers the respectively provided hand control elements, so that for the purpose of guiding such a computer mouse it is necessary to place the hand with the ball of the hand on the guide surface for the computer mouse in order to grasp the housing from above and to guide the same laterally between the thumb on the one hand and the middle and ring finger on the other hand, whereas the index finger remains free for operating the hand control elements. The posture of the hand enforced by such mice with the back of the hand facing upwardly causes a twisting of the hand in the wrist as opposed to a natural basic posture in which the hand rests on the side of the hand. In order to take this basic posture into account, it has already been proposed (U.S. Pat. No. 5,576,733 A, U.S. Pat. No. 5,894,303 A, US 2003/0206152 A1) to provide the housing of a computer mouse with a jacket surface protruding upwardly from the support surface and tapering away from the support surface, which jacket surface is enclosed by the surface of the hand so that the jacket surface will snugly fit into surface of the hand enclosing the housing as a result of the adjustment of the housing to the anatomical conditions. Although such housings of mice which form a grasping element which can be enclosed substantially by one hand ensure ergonomic handling, the computer mouse still needs to be guided by a movement of the entire hand, which is contrary to a finely tuned displacement of the computer mouse over a small area.

### SUMMARY OF THE INVENTION

The invention is thus based on the object of providing a computer mouse of the kind mentioned above in such a way that not only handling is achieved with a posture of the hand corresponding to a natural basic position but also a fine-tuned movement of the housing over a small space is ensured.

This object is achieved by the invention in such a way that the jacket surface is arranged in a conical way with generatrices extending substantially in a straight line and has a height of the width of three fingers for the purpose of supporting a thumb on one circumferential side and an index finger and a middle finger on the opposite circumferential side.

Since the jacket surface is limited in its height to the width of three fingers, the enclosure of the jacket surface of the housing by a hand can be excluded, thus resulting in an unconstrained guidance of the computer mouse between the thumb on the one hand and the index and middle finger of a hand on the other hand, which guidance is supported on the guide surface for the computer mouse via the side of the hand and the small finger which is generally bent in against the surface of the hand together with the ring finger and places itself between the computer mouse and the surface of the hand, thus corresponding to a natural basic posture of the hand. The guide hand which is supported in this manner moves the computer mouse merely over the thumb and the index and middle finger, leading to a finely tuned movement of the computer mouse as a result of the fine motor skills inherent in these fingers. The conical jacket surface with generatrices extending in a substantially straight manner offers an advantageous support for the fingers on the jacket surface of the housing without having to provide handle recesses for this purpose. Sequences of movements can thus be achieved with respect to the computer mouse guidance as are otherwise only possible in the guidance of a writing implement, but with the relevant advantage that the housing need not be held as a result of the conical jacket surface, but merely needs to be guided.

The housing of a computer mouse in accordance with the invention can be provided with conventional hand control elements which are preferably arranged on mutually opposite circumferential sides of the jacket surface in the region of the finger support. If the jacket surface is provided with the hand control elements with a symmetrical arrangement with respect to an axial plane by the mutually opposite circumferential sides, the computer mouse can be used similarly by right-handed as well as left-handed persons. Especially simple constructional conditions are obtained in this connection when the jacket surface forms a circular conical surface, with a natural handling of the computer mouse from the basic position of the hand being obtained in an unconstrained manner due to the hand control elements on mutually opposite circumferential sides.

To ensure that an actuating of press-buttons as hand control elements does not lead to any displacement of the computer mouse, a respective counter-pressure must be exerted via the guide fingers in the case of an arrangement of these hand control elements on a jacket surface protruding from the support surface of the computer mouse. In order to ensure that the burden on the hand caused by such a counter-pressure can be kept small, the arrangement can be made in a configuration of the hand control elements as press-buttons in such a way that the actuating direction of the press-buttons intersects with the support surface of the housing within the jacket surface, so that in the case of an actuation of the press-buttons a considerable force component is obtained perpendicular to the support surface.

If hand control elements are provided in the form of actuating wheels, their shaft can extend parallel to a tangent on the jacket surface. A further advantageous embodiment is obtained when the shaft of such an actuating wheel extends in the direction of the axis of the jacket surface, which is generally entailed by an actuating wheel in the region of the cover surface of the housing.

In order to further facilitate the handling of the housing, the jacket surface can be provided with a non-slip arrangement in the region of the finger supports, e.g. with the help of a non-slip coating.

### BRIEF DESCRIPTION OF THE DRAWINGS

The subject matter of the invention is shown in the drawing by way of example, wherein:

FIG. 1 shows a computer mouse in accordance with the invention in a schematic side view, and

FIG. 2 shows an embodiment of a computer mouse in accordance with the invention with a press-button and an actuating wheel in a side view.

### DESCRIPTION OF THE PREFERRED EMBODIMENTS

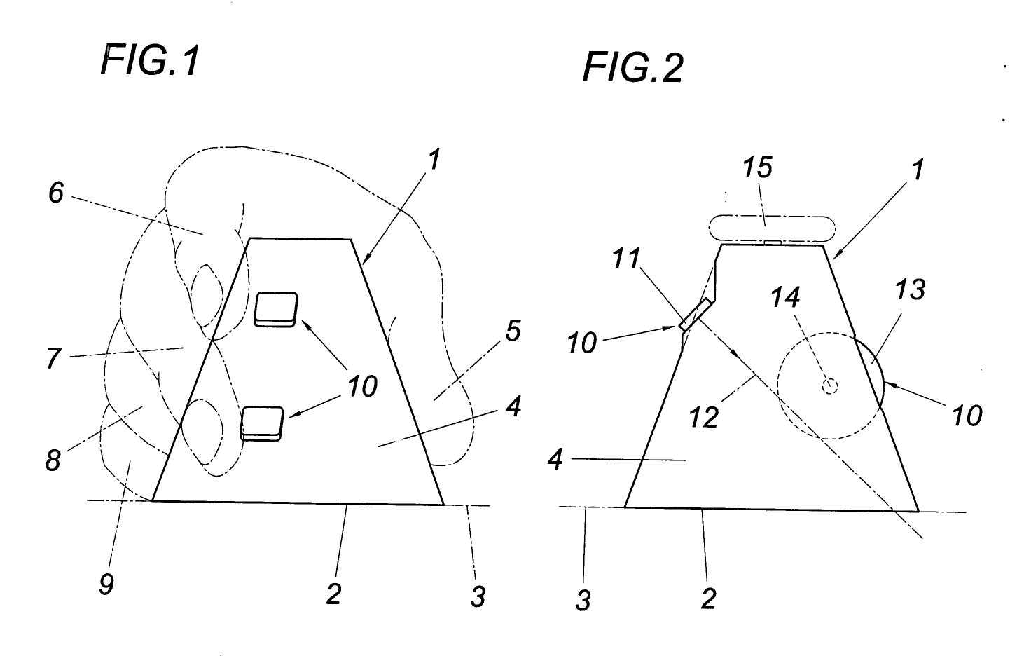

In accordance with the illustrated embodiments, the computer mouse comprises a housing 1 with a support surface 2 resting on a guide base 3. The jacket surface 4 of housing 1 which protrudes upwardly from said support surface 2 is provided with a substantially conical arrangement and rests in the case of this embodiment on a circular cone. The relevant aspect for such conical jacket surface is its limitation to the height of the width of three fingers, so that said jacket surface 4 cannot be enclosed by the surface of the hand. This means that the housing 1 is guided merely between the thumb 5 on the one hand and the index finger 6 and the middle finger 7 on the other hand, with the hand resting on the side of the hand and the small finger 8 and the ring finger 9 on the guide base 2 and therefore assuming a natural basic posture, as is indicated in FIG. 1 with the dot-dash line. As a result of this upright basic posture of the hand, the housing 1 can be moved in a finely adjusted manner on the guide base 3 by means of the fingers 5, 6 and 7 resting on opposite circumferential sides of the jacket surface 4, which occurs similar to a writing implement, but without the necessity of having to hold the computer mouse like a writing implement because the housing 1 rests via the support surface 2 on the guide base 3.

The jacket surface 4 can be provided in the known manner with hand control elements 10 which are arranged in an advantageous manner on mutually opposite circumferential sides in the supporting region of the index finger 6 and the middle finger 7 on the one hand and the thumb 5 on the other hand. If press-buttons 11 are used as hand control elements 10, especially advantageous conditions are obtained with respect to the handling of the computer mouse when according to FIG. 2 the actuating direction 12 of the press-buttons 11 intersects within the jacket surface 4 with the support surface 2 because in this case the force component leading to a displacement of the housing 1 parallel to the guide base 3 will be comparatively small and the counter-pressure by the thumb 5 for example can be kept at a low level for example, thus reducing the stress on the hand.

When the actuating wheels 13 are used as hand control elements 10, its shaft 14 can extend parallel to a tangent on the jacket surface 4, as is illustrated for the actuating wheel 13 in FIG. 2 which is shown with the unbroken lines. It is also possible to provide an actuating wheel 15 whose shaft extends in the direction of the axis of the jacket surface 4, as is indicated in FIG. 2 with the dot-dash line. The shaft of an actuating wheel could also extend parallel to a generatrix of the jacket surface under certain circumstances.

The diameter of the support surface 2 and the angle of inclination of a generatrix of the jacket surface 4 relative to this support surface 2 can be different because it is merely relevant to provide a housing 1 with a jacket surface 4 which in the case of a natural finger posture can be grasped in the manner of tongs between thumb 5 on the one hand and the index finger 6 and middle finger 7 on the other hand. In the case of a predetermined height of the jacket surface 4 of the width of three fingers, which corresponds to an average height of between 4 and 6 cm, a support surface 2 is obtained with a diameter of usually 3.5 to 5.5 cm and an angle of inclination of between 65 and 80°.

1. A computer mouse with a housing which comprises a support surface and a jacket surface for finger support, which jacket surface protrudes upwardly in a tapering manner from the support surface, wherein the jacket surface (4) is arranged in a conical way with generatrices extending substantially in a straight line and has a height of the width of three fingers for the purpose of supporting a thumb (5) on one circumferential side and an index finger and a middle finger (6, 7) on the opposite circumferential side.

2. A computer mouse according to claim 1, wherein housing is provided with hand control elements (10) on mutually opposite circumferential sides of the jacket surface in the region of the finger support and that the jacket surface (4) is provided with a symmetrical arrangement with respect to an axial plane by the mutually opposite circumferential sides.

3. A computer mouse according to claim 1, wherein the jacket surface (4) forms a circular conical surface.

4. A computer mouse according to claim 1, wherein in the case of an arrangement of the hand control elements (10) as press-buttons (11) their direction of actuation (12) intersects with the support surface (2) within the jacket surface (4).

5. A computer mouse according to claim 1, wherein in the case of an arrangement of the hand control elements (10) as an actuating wheel (13) its shaft (14) extends parallel to a tangent on the jacket surface (4).

6. A computer mouse according to claim 1, wherein in the case of an arrangement of the hand control elements (10) as an actuating wheel (15) its shaft extends in the direction of the axis of the jacket surface (4).

7. A computer mouse according to claim 1, wherein the jacket surface (4) is provided with an anti-slip arrangement in the region of the supports of the fingers.
